(19) United States
(12) Patent Application Publication
(10) Pub. No.: US 2026/0044292 A1
(43) Pub. Date: Feb. 12, 2026

(54) PRINTING DEVICE, PRINTING METHOD, PRINTING SYSTEM, MANUFACTURING LINE, AND MANUFACTURING METHOD

(71) Applicant: MIMAKI ENGINEERING CO., LTD., Nagano (JP)

(72) Inventor: Satoshi Hamamura, Nagano (JP)

(73) Assignee: MIMAKI ENGINEERING CO., LTD., Nagano (JP)

(21) Appl. No.: 18/995,812

(22) PCT Filed: Jul. 25, 2023
(86) PCT No.: PCT/JP2023/027088

§ 371 Date: Jan. 16, 2025

(30) Foreign Application Priority Data
Jul. 26, 2022 (JP) 2022-118425

(51) Int. Cl. G06F 3/12; B41J 2/175; B41J 29/387

(52) U.S. Cl. CPC G06F 3/1218; B41J 2/17566; B41J 29/387; G06F 3/1205; B41J 2002/17573; B41J 2002/17589

(57) ABSTRACT

A printing execution unit (111) of a printing device (100) executes printing of the printing surface identified by printing surface identification information based on printing instruction data including resultant product identification information for identifying a resultant product of printing, a total printing surface number, which is a total number of the printing surface to be printed to obtain the resultant product, printing surface identification information for identifying a printing surface, and printing data of the printing surface identified by the printing surface identification information. A printing history output unit (112) outputs a printing history indicating a result of printing executed based on the printing instruction data including the same resultant product identification information in association with the resultant product identification information.

### TECHNICAL FIELD

The present disclosure relates to a printing device, a printing method, a printing system, a manufacturing line, and a manufacturing method.

### BACKGROUND ART

When printing is performed by a printing device such as an inkjet printer, printing is performed by receiving printing data from a host computer, and controlling a head according to the printing data. Normally, data for the number of nozzles when nozzles used for printing are caused to perform one scanning constitutes data for one scan, and data for a plurality of scans constitutes printing data in units of one page. An inkjet printer that executes printing based on such printing data in units of one page and manages a printing history is known (e.g., Patent Literature 1).

Patent Literature 1 is described that the inkjet printer described in Patent Literature 1 can efficiently control the printing process by generating scan data based on data in units of bands obtained by dividing one page in the sub scanning direction.

On the other hand, some recent inkjet printers are capable of printing by layering a plurality of ink layers on a medium using ink that cures by heat, ultra violet (UV), or the like (e.g., Patent Literature 2).

The inkjet printer described in Patent Literature 2 is described to be capable of achieving high printing image quality by controlling a first ink head that ejects a specific color ink and a second ink head that ejects a process color ink to execute overprinting.

### CITATION LIST

### Patent Literature

Patent Literature 1: Japanese Unexamined Patent Publication No. 2007-261096

Patent Literature 2: Japanese Unexamined Patent Publication No. 2018-187820

### SUMMARY OF INVENTION

### Technical Problems

In the case of the inkjet printer described in Patent Literature 1, a printing history including the amount of ink required for printing in units of one page, the printing time, and the like is managed, and the cost and the like related to printing of one printing data can be calculated. However, in the case of printing multiple layers including a plurality of layers to be simultaneously printed as in the inkjet printer described in Patent Literature 2, it is necessary to collect and analyze the history of printing performed to complete one resultant product.

The printing data received by the printing device that prints multiple layers is data for one printing surface (for one feed), and the printing history is also information for one printing surface, and thus it is necessary for the administrator to extract and integrate data for all printing surfaces related to the same resultant product, and there is a problem that it takes time and management cost.

The present disclosure has been made in view of the above circumstances, and an object thereof is to provide a printing device, a printing method, a printing system, a manufacturing line, and a manufacturing method that can appropriately acquire and analyze a printing history related to a resultant product even when executing printing of a plurality of layers.

### Solutions to Problems

In order to achieve the above object, a printing device according to a first aspect of the present disclosure includes a printing execution unit configured to execute printing of a printing surface identified by printing surface identification information based on printing instruction data including: resultant product identification information for identifying a resultant product of printing, a total printing surface number, which is a total number of the printing surface to be printed to obtain the resultant product, the printing surface identification information for identifying the printing surface, and printing data of the printing surface identified by the printing surface identification information, and
a printing history output unit configured to output a printing history indicating a result of printing executed based on the printing instruction data including the same resultant product identification information in association with the resultant product identification information.

The printing history output by the printing history output unit may include printing progress information derived based on the printing surface identification information of the printing surface on which the printing execution unit has executed printing and the total printing surface number.

The printing history output by the printing history output unit may include an ink consumption amount consumed by printing of the printing surface or a printing cost based on the ink consumption amount.

The printing history output by the printing history output unit may include information indicating that printing has been completed or the printing surface identification information related to the printing surface on which an error has occurred when the number of printing surfaces on which the printing execution unit has executed printing is the same as the total printing surface number.

Furthermore, a printing method according to a second aspect of the present disclosure includes steps of: a receiving step of receiving printing instruction data including: resultant product identification information for identifying a resultant product of printing, a total printing surface number, which is a total number of a printing surface to be printed to obtain the resultant product, printing surface identification information for identifying the printing surface, and printing data of the printing surface identified by the printing surface identification information,
a printing execution step of executing printing of the printing surface identified by the printing surface identification information based on the printing instruction data, and
an outputting step of outputting a printing history indicating a result of printing executed based on the printing instruction data including the same resultant product identification information in association with the resultant product identification information.

In addition, a printing system according to a third aspect of the present disclosure includes a printing device configured to execute printing of a printing surface identified by printing surface identification information based on printing instruction data including: resultant product identification information for identifying a resultant product of printing, a total printing surface number, which is a total number of the printing surface to be printed to obtain the resultant product, the printing surface identification information for identifying the printing surface, and printing data of each printing surface identified by the printing surface identification information, and output a printing history indicating a result of printing in association with the resultant product identification information, and
an information processing terminal configured to output printing progress information or a printing cost of the resultant product identified by the resultant product identification information based on the printing history output by the printing device.

The printing system may include a plurality of the printing devices configured to execute printing of different printing surfaces among a plurality of the printing surfaces, and
the information processing terminal may output the printing progress information or the printing cost of the resultant product based on the printing history associated with the resultant product identification information received from the plurality of the printing devices.

The printing instruction data including the resultant product identification information, the total printing surface number, the printing surface identification information for identifying each of the printing surface, and the printing data of each of the printing surface may be transmitted to each printing device configured to execute printing of each printing surface determined based on the printing data of the plurality of the printing surfaces, and each of the printing device may execute printing based on the printing instruction data received.

The printing instruction data may be transmitted to each of the printing device configured to execute printing of each of the printing surface determined based on at least one piece of management information of specifications, ink remaining amounts, and maintenance states of the plurality of the printing devices and the printing data of the plurality of the printing surfaces.

Furthermore, a manufacturing line according to a fourth aspect of the present disclosure includes the printing device according to the first aspect, in which an operation of a preceding process or a subsequent process is controlled based on the printing history associated with the resultant product identification information.

Moreover, a manufacturing method according to a fifth aspect of the present disclosure includes steps of: a printing execution step of executing printing of a printing surface identified by printing surface identification information based on printing instruction data including resultant product identification information for identifying a resultant product of printing, a total printing surface number, which is a total number of the printing surface to be printed to obtain the resultant product, the printing surface identification information for identifying the printing surface, and printing data of the printing surface identified by the printing surface identification information,
an outputting step of outputting a printing history indicating a result of printing executed in the printing execution step in association with the resultant product identification information, and
a controlling step of controlling an operation of a preceding process or a subsequent process based on the printing history associated with the resultant product identification information.

### EFFECT OF THE INVENTION

According to the present disclosure, the association of the printing history is facilitated by the resultant product identification information, and the progress can be easily grasped by the total printing surface number and the printing surface identification information, so that even when printing of a plurality of layers is executed, the printing history related to the resultant product can be appropriately acquired and analyzed.

### BRIEF DESCRIPTION OF THE DRAWINGS

FIG. 1 is a block diagram illustrating a configuration example of a printing system according to a first embodiment.

FIG. 2 is a diagram illustrating an example of a resultant product of printing.

FIG. 3 is a flowchart of a printing execution process.

FIG. 4 is a block diagram illustrating a configuration example of a printing system according to a second embodiment.

FIG. 5 is a sequence diagram illustrating an operation of the printing system.

### DESCRIPTION OF EMBODIMENTS

Hereinafter, embodiments of the present disclosure will be described with reference to the drawings. Note that in the drawings, the same or corresponding parts are denoted by the same reference numerals.

### First Embodiment

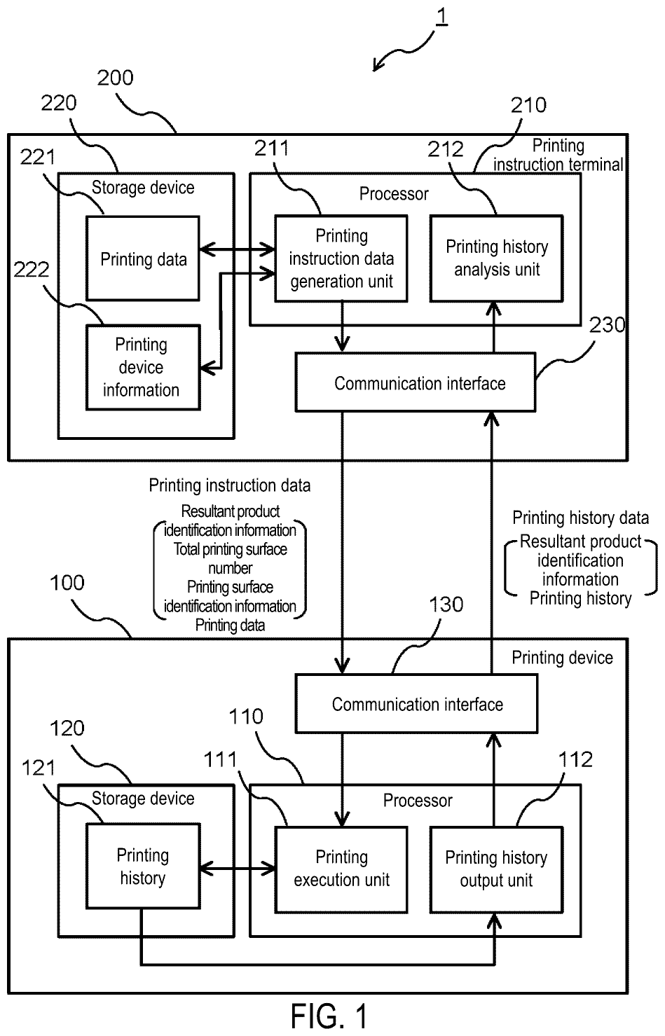

FIG. 1 is a block diagram illustrating a configuration example of a printing system 1 according to a first embodiment of the present disclosure. As illustrated in FIG. 1, the printing system 1 includes a printing device 100 that executes printing on a medium, and a printing instruction terminal 200 that issues a printing instruction to the printing device 100 to execute printing and manages the printing device 100.

The printing device 100 is any printing device that performs printing based on a printing instruction from the printing instruction terminal 200, and is, for example, an inkjet printer. The printing device 100 performs printing on both sides or one side, or printing of a plurality of layers.

The printing device 100 has, for example, a function of ejecting an ultraviolet curable ink onto a medium and curing the ink by irradiating the ultraviolet light to form an ink layer, and includes a nozzle that ejects ink droplets, and an ultraviolet irradiator that cures the ink ejected from the nozzle.

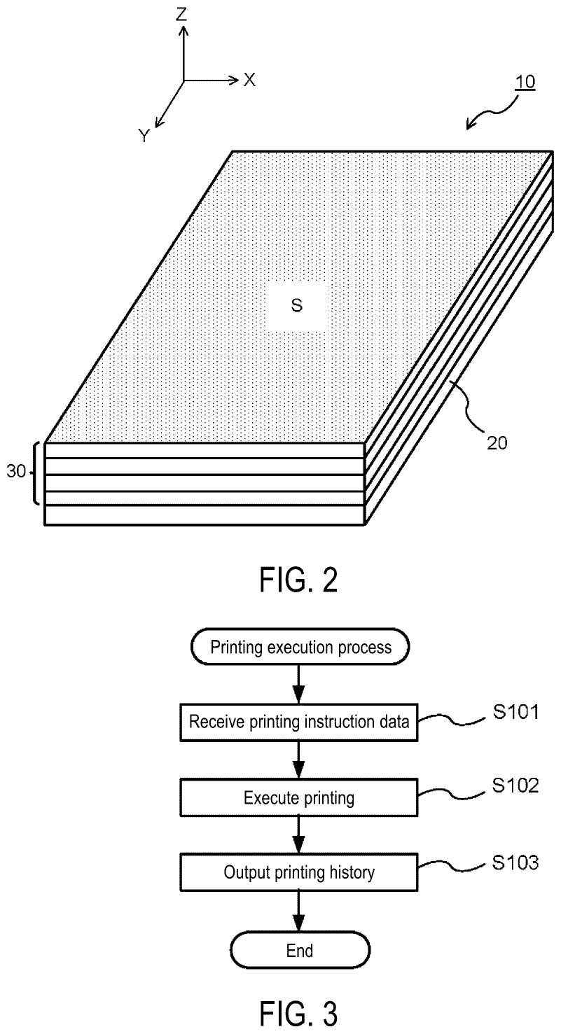

FIG. 2 illustrates an example of a resultant product 10 of printing by the printing device 100. The printing device 100 includes a plurality of ink nozzles arrayed in the main scanning direction X and the sub scanning direction Y with respect to the medium 20. The printing device 100 repeatedly executes a scan operation of ejecting ink while moving the ink nozzle in the main scanning direction X while moving in the sub scanning direction Y a predetermined number of times, and performs printing of one printing surface (one feed) S. Furthermore, the printing of the printing surface (feed) S is executed a plurality of times to obtain the resultant product 10 including the plurality of printing layers 30 layered in the thickness direction Z. That is, the printing surface S is a unit for performing printing in a divided manner in the resultant product 10, and is a unit in which the dot matrix arrayed in the main scanning direction X and the sub scanning direction Y is configured by a predetermined number of scanning. Note that the printing device 100 may simultaneously execute printing of two or more layers of the plurality of printing layers 30 in the printing of one printing surface S.

As illustrated in FIG. 1, the printing device 100 includes a processor 110, a storage device 120, and a communication interface 130. The processor 110 is, for example, a central processing unit (CPU), and functions as a printing execution unit 111 and a printing history output unit 112 by reading and executing a control program stored in the storage device 120.

The printing execution unit 111 executes printing based on printing instruction data received from the printing instruction terminal 200 via the communication interface 130. The printing history output unit 112 outputs a printing history 121 indicating various results of printing executed by the printing execution unit 111 to the printing instruction terminal 200.

The storage device 120 stores a control program executed by the processor 110 in addition to the printing history 121 by the printing execution unit 111. The storage device 120 is, for example, a nonvolatile semiconductor memory such as an Electrically Erasable Programmable Read-Only Memory (EEPROM) or a flash memory. The communication interface 130 is an arbitrary interface that transmits and receives data to and from the printing instruction terminal 200.

The printing instruction terminal 200 is an arbitrary information processing terminal in which a driver corresponding to the printing device 100 is installed, and is, for example, a personal computer (referred to as RIP-PC) that functions as a raster image processor (RIP). The RIP-PC is a computer that converts arbitrary character/image data into printing data 221 in a raster data format and outputs printing instruction data including the printing data 221 to the printing device 100.

As illustrated in FIG. 1, the printing instruction terminal 200 includes a processor 210, a storage device 220, and a communication interface 230. The processor 210 is, for example, a CPU, and functions as a printing instruction data generation unit 211 and a printing history analysis unit 212 by reading and executing a control program stored in the storage device 220.

The printing instruction data generation unit 211 converts arbitrary character/image data into printing data 221 in a raster data format, generates printing instruction data including the printing data 221, and transmits the printing instruction data to the printing device 100 via the communication interface 230. The printing history analysis unit 212 analyzes the printing history 121 acquired from the printing device 100 via the communication interface 230.

The storage device 220 stores printing data 221 and printing device information 222. The printing device information 222 is information related to the printing device 100 including a specification, a printing condition, or an operation status of the printing device 100. Furthermore, the storage device 220 stores a control program executed by the processor 210. The storage device 220 is, for example, a nonvolatile semiconductor memory such as an EEPROM or a flash memory. The communication interface 230 is an interface of any communication scheme corresponding to the communication interface 130 of the printing device 100.

Here, printing instruction data and printing history data transmitted and received between the printing device 100 and the printing instruction terminal 200 will be described in detail. The printing instruction data includes printing data 221 that is data in units of printing surfaces. More specifically, data for the number of nozzles when nozzles used for printing are caused to perform one scanning in the main scanning direction constitutes data for one scan, and data for all scans in the sub scanning direction constitutes printing data 221 in units of printing surfaces. Note that even when simultaneously printing two or more layers, one time of all scans in the sub scanning direction may be adopted as the printing data 221 of one printing surface.

In addition to the printing data 221, the printing instruction data includes resultant product identification information (job ID), a total printing surface number (total number of feeds), and printing surface identification information (feed ID). The resultant product identification information is information for identifying the resultant product (job) 10, but since the printing device 100 executes printing of a plurality of printing surfaces (a plurality of feeds) to manufacture one resultant product 10, the same resultant product identification information is attached to a plurality of pieces of printing instruction data. Although the form of the resultant product identification information is arbitrary, for example, the resultant product identification information may be a character string representing the data creation date and time.

The total printing surface number is the total number of the printing surface to be printed on the medium 20 of the resultant product 10. Note that when simultaneously printing two or more layers, the two or more layers to be simultaneously printed are counted as one printing surface. In order to execute printing of a plurality of printing surfaces to manufacture one resultant product 10, the same total printing surface number is attached to the plurality of pieces of printing instruction data. Note that the case where the total printing surface is one may also be included.

The printing surface identification information is information for identifying a printing surface by the printing data 221 included in the printing instruction data, and is, for example, a number assigned in ascending order from the side closer to the medium 20 with respect to the printing surface of the total printing surface number.

The printing execution unit 111 of the printing device 100 executes printing by each printing surface based on the printing instruction data received from the printing instruction terminal 200, and stores a printing history 121 indicating various results of printing for each printing surface in the storage device 120.

The printing history 121 includes, for example, information such as normal, abnormal, error termination, and cancellation for the executed printing result. Furthermore, the printing history 121 may include at least one of an ink consumption amount for each printing surface, a start date and time, an end date and time, a printing width, and a printing length. Furthermore, the printing history 121 may also include printing conditions such as resolution, pass number, and scan speed. The printing history 121 is stored in association with the resultant product identification information included in the printing instruction data.

The printing histories 121 executed by the printing execution unit 111 are integrated based on the printing instruction data respectively including the same resultant product identification information. For example, the printing history 121 may include printing progress information derived based on the printing surface identification information of the printing surface executed by the printing execution unit 111 and the total printing surface number. Furthermore, the printing history 121 may include the ink consumption amount of the entire resultant product 10 obtained by adding up the ink consumption amounts of each printing surface or the printing cost based on the ink consumption amount. The printing cost may be calculated including a time cost calculated from the printing time and a cost of a consumption material such as a medium.

Furthermore, the printing history 121 may include information indicating that the printing of the resultant product 10 has been completed or printing surface identification information indicating a printing surface on which an error has occurred when the number of printing surfaces executed by the printing execution unit 111 is the same as the total printing surface number. Alternatively, the printing history 121 may include the total time required to print all the printing surfaces of the resultant product 10.

The printing history output unit 112 transmits the printing history 121 integrated with respect to the same resultant product identification information to the printing instruction terminal 200 as printing history data together with the resultant product identification information. The printing history data may be output in the middle of printing of the resultant product 10. Even when there is a time difference in printing of each printing surface, the progress information of printing can be acquired from the printing history 121 in the middle.

The operation of the printing system 1 configured as described above will be described along the flowchart of FIG. 3. FIG. 3 is a printing execution process executed by the printing device 100.

The printing instruction terminal 200 transmits printing instruction data for each printing surface (for each feed) to the printing device 100. The printing instruction data includes resultant product identification information (job ID), a total printing surface number (total number of feeds), printing surface identification information (feed ID), and printing data.

The printing device 100 receives the printing instruction data (step S101: reception step), and the printing execution unit 111 executes printing based on the printing instruction data (step S102: printing execution step). At this time, the printing execution unit 111 stores the printing history 121 indicating the result of printing in the storage device 120 together with the resultant product identification information.

The printing execution unit 111 receives printing instruction data for the number of printing surfaces and executes printing, and integrates the printing histories 121 associated with the same resultant product identification information among the printing histories 121 stored after printing of each printing surface. The printing history output unit 112 outputs the integrated printing history 121 together with the resultant product identification information to the printing instruction terminal 200 (step S103: output step).

The printing history analysis unit 212 of the printing instruction terminal 200 analyzes the printing history 121 acquired from the printing device 100 via the communication interface 230. Specifically, the printing history analysis unit 212 may collate the printing data 221 and the printing device information 222 with the printing cost based on the resultant product identification information, and derive the relationship between the printing data 221 and the printing cost.

For example, the printing instruction terminal 200 may perform machine learning with the printing data 221 and the printing condition or the specification of the printing device 100 as inputs and the printing cost or the printing time included in the printing history 121 acquired from the printing device 100 as an output, and predict and present the printing cost or the printing time using the generated learning model.

As described above, in the printing device 100 of the printing system 1 according to the present embodiment, the printing execution unit 111 executes printing of the printing surface identified by the printing surface identification information based on the printing instruction data including the resultant product identification information that identifies the resultant product 10 of printing, the total printing surface number, which is the total number of the printing surface to be printed to obtain the resultant product 10, the printing surface identification information for identifying a printing surface, and the printing data of the printing surface. Then, the printing history output unit 112 integrates the printing history 121 executed by the printing execution unit 111 based on the printing instruction data including the same resultant product identification information, and outputs the integrated printing history in association with the resultant product identification information. This makes it possible to appropriately acquire and analyze the printing history 121 related to the resultant product 10 even in a case where printing of a plurality of layers is executed.

Furthermore, the printing history 121 may include printing progress information derived based on the printing surface identification information of the printing surface executed by the printing execution unit 111 and the total printing surface number, or an ink consumption amount consumed by printing of the printing surface or printing cost based on the ink consumption amount. Alternatively, when the number of printing surfaces on which printing has been executed is the same as the total printing surface number, information indicating that printing has been completed or printing surface identification information of a printing surface on which an error has occurred may be included. This makes it possible to appropriately acquire and analyze the progress and cost of printing of a plurality of layers.

### Second Embodiment

Hereinafter, a second embodiment for carrying out the present disclosure will be described in detail with reference to the drawings. Note that in the drawings, the same reference numerals are given to the same parts as those in the first embodiment or parts corresponding thereto.

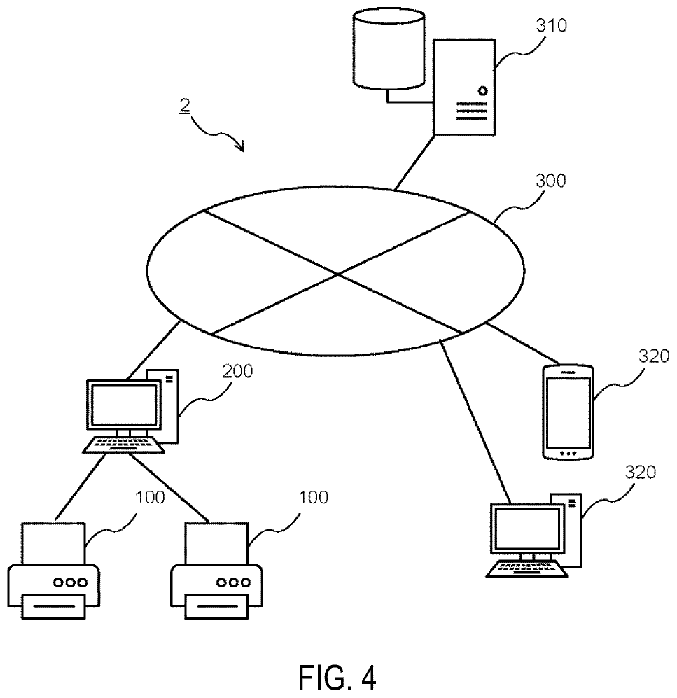

FIG. 4 is a block diagram illustrating a configuration example of a printing system 2 according to a second embodiment of the present disclosure. As illustrated in FIG. 4, the printing system 2 according to the second embodiment includes one or more printing instruction terminals 200, and one or more printing devices 100 that execute printing based on printing instruction data transmitted from each printing instruction terminal 200. The printing system 2 further includes a server 310 connected to the printing instruction terminal 200 via an arbitrary network 300, and a management terminal 320.

The configuration, function, and operation of each of the printing device 100 and the printing instruction terminal 200 are similar to those of the first embodiment. In the present embodiment, the printing of one resultant product 10 including a plurality of printing layers 30 is carried out by one or more printing devices 100. That is, the printing instruction terminal 200 allocates printing of each printing surface to one or more printing devices 100. In a case where the printing of the plurality of printing surfaces is shared by the plurality of printing devices 100, the load of the printing device 100 can be distributed, and the overall resultant productivity can be improved.

The printing instruction terminal 200 allocates printing instruction data having the same resultant product identification information and different printing surface identification information to each printing device 100, and sequentially transmits the allocated printing instruction data to each printing device 100. Each printing device 100 executes printing based on the printing instruction data after the automatic or manual setting of the medium 20 is completed.

Note that the allocation of the printing surface with respect to one or more printing devices 100 by the printing instruction terminal 200 may be automatically performed based on the content of the printing data 221 or management information such as the specification, ink remaining amount, or maintenance state of each printing device 100. resultant productivity can be improved by allocating the printing device 100 by predicting the printing time or the idling time based on the content of the printing data 221 and the specification of each printing device 100.

Furthermore, ink runout can be avoided by allocating the printing device 100 based on the ink remaining amount. In addition, by allocating the printing device 100 based on the maintenance state, it becomes possible to raise the operation rate of the printing device 100 in good condition and improve the overall resultant productivity.

After executing printing, each printing device 100 transmits the printing history 121, to which the resultant product identification information is attached, to the printing instruction terminal 200. The printing instruction terminal 200 integrates or analyzes the printing history 121 for each resultant product based on the resultant product identification information, and uploads the integrated printing history to the server 310.

Specifically, the printing instruction terminal 200 derives the printing progress information based on the printing surface identification information and the total printing surface number included in the printing history 121 having the same resultant product identification information, and uploads the printing progress information to the server 310. Alternatively, the printing instruction terminal 200 adds up the printing costs including the time cost and the consumption material cost included in the printing history 121 having the same resultant product identification information, calculates the cost related to the resultant product 10, and uploads the cost to the server 310.

Note that the printing instruction terminal 200 may upload to the server 310 the printing history 121 received from the printing device 100 as is or by partially integrating, and the printing history 121 may be integrated or analyzed for each resultant product 10 in the server 310.

The server 310 analyzes the printing history 121 acquired from the printing instruction terminal 200 via the network 300. Specifically, the server 310 may collate the printing data 221 and the printing device information 222 with the printing cost or the printing time based on the resultant product identification information, and derive the relationship between the printing data 221 and the printing cost or the printing time.

For example, the server 310 may perform machine learning with the printing data 221 and the printing condition or the specification of the printing device 100 as inputs and the printing cost or the printing time included in the printing history 121 as an output, and predict and the printing cost or the printing time using the generated learning model. The server 310 may further periodically collect information on the operation status of each printing device 100.

The management terminal 320 downloads an analysis result of the printing history of the server 310. For example, the management terminal 320 downloads and displays the printing history 121 of the printing device 100 and the cost for each resultant product. Furthermore, the management terminal 320 may acquire the operation status of each printing device 100 from the server 310.

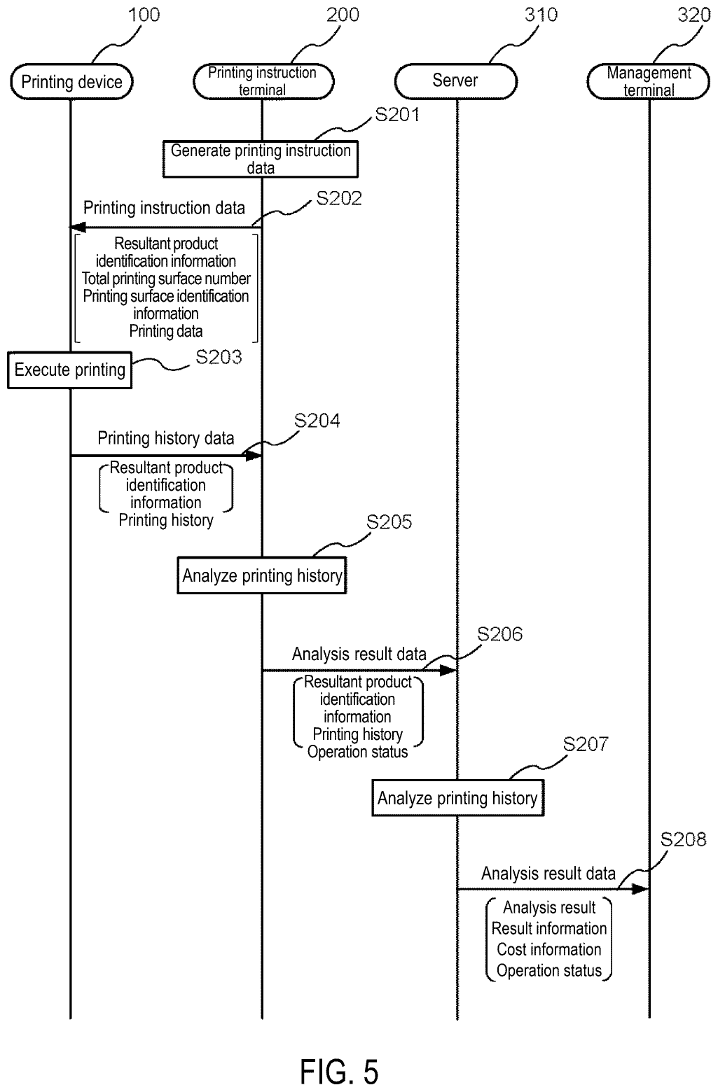

The operation of the printing system 2 configured as described above will be described with reference to the sequence diagram of FIG. 5. FIG. 5 is a sequence diagram illustrating an operation of the printing system 2. Note that although the printing system 2 includes any number of one or more of the printing device 100, the printing instruction terminal 200, the server 310, and the management terminal 320, FIG. 5 illustrates a case where one of each of the printing device 100, the printing instruction terminal 200, the server 310, and the management terminal 320 is provided.

First, the printing instruction terminal 200 generates printing instruction data for each printing surface (for each feed) constituting the resultant product 10 (step S201), and transmits the printing instruction data to the printing device 100 (step S202). In a case where the printing of the plurality of printing surfaces is shared and executed by the plurality of printing devices 100, the printing instruction terminal 200 transmits printing instruction data related to the printing surface to be shared to each printing device 100. The printing instruction data includes resultant product identification information (job ID), a total printing surface number (total number of feeds), printing surface identification information (feed ID), and printing data.

The printing execution unit 111 of the printing device 100 executes printing based on the received printing instruction data (step S203: printing execution step). At this time, the printing execution unit 111 stores the printing history 121 indicating various results of printing in the storage device 120 in association with the resultant product identification information. In a case where printing is executed based on the printing instruction data related to a plurality of printing surfaces respectively associated with the same resultant product instruction information, the printing device 100 may integrate the plurality of printing histories 121. The printing history output unit 112 outputs the printing history 121 related to each printing surface or the integrated printing history 121 together with the resultant product identification information to the printing instruction terminal 200 as printing history data (step S204: output step).

The printing history analysis unit 212 of the printing instruction terminal 200 analyzes the printing history 121 acquired from the printing device 100 (step S205), and uploads the analysis result data to the server 310 (step S206). For example, the printing instruction terminal 200 uploads, to the server 310, the analysis result data including the cost related to the resultant product 10 obtained by adding up the printing costs included in the printing histories 121 having the same resultant product identification information with each other. Furthermore, the printing instruction terminal 200 may also upload the operation status received from the printing device 100.

The printing instruction terminal 200 may upload to the server 310 the printing history 121 received from the printing device 100 as is or by partially integrating, and the printing history 121 may be integrated or analyzed for each resultant product 10 in the server 310.

The server 310 collects analysis result data including the printing history 121 acquired from the printing instruction terminal 200 via the network 300, and further analyzes the analysis result data (step S207). For example, the server 310 collates the printing data 221 with the printing cost based on the resultant product identification information, and derives a relationship between the printing data 221 and the printing cost. The server 310 may further periodically collect information on the operation status of each printing device 100.

The management terminal 320 downloads the analysis result data including the analysis result of the printing history 121, the result information, or the cost information from the server 310 (step S208). For example, the management terminal 320 downloads the printing result of the printing device 100 and the cost for each resultant product. Furthermore, the management terminal 320 may acquire the operation status of each printing device 100 from the server 310.

As described above, in the printing system 2 according to the present embodiment, the printing instruction terminal 200 transmits the printing instruction data including the resultant product identification information, the total printing surface number, the printing surface identification information, and the printing data to one or more printing devices 100, and each printing device 100 executes printing of each printing surface based on the printing instruction data and outputs the printing history 121 in association with the resultant product identification information. Then, the printing instruction terminal 200 integrates the printing histories 121 received from each of the printing devices 100, and outputs the printing progress information or the printing cost of the resultant product 10. As a result, the printing progress information or the printing cost of the resultant product 10 can be simply and accurately acquired, the printing load of each printing device 100 can be reduced, and the overall resultant productivity of the resultant product 10 can be improved.

Note that in the first and second embodiments, the printing instruction terminal 200 acquires the printing history 121 from the printing device 100 and integrates the printing history, but an information processing terminal different from the printing instruction terminal 200, such as the server 310 or the management terminal 320, may acquire the printing history 121 from the printing device 100 and integrate the printing history.

In addition to the printing systems 1 and 2 according to the first and second embodiments, the resultant product identification information may be shared in the entire manufacturing line including another manufacturing device, a conveyance device, or an inspection device, and process management and cost calculation may be performed. That is, the printing history 121 associated with the resultant product identification information may be shared with a preceding process or a subsequent process of the printing process, and the operation of the preceding process or the subsequent process may be controlled based on the printing history 121 (control step).

As a result, it is possible to avoid resultant production defect or failure of the manufacturing device due to, for example, a next medium 20 being conveyed from the preceding process and input to the printing device 100 even though the previous printing has not been completed, or the medium 20 being conveyed to the next process before the printing is completed. Furthermore, at the timing when the printing process is normally completed, the conveyance of the medium 20 from the preceding process, the conveyance of the medium 20 to the subsequent process, the work or inspection of the subsequent process, and the like can be carried out in a timely manner, and the resultant production efficiency or the shipping efficiency can be improved. In addition, it also becomes easy to specify a process in which a defect has occurred among the previous process, subsequent process, and the printing process.

The present invention enables various embodiments and modified examples without deviating from the broad spirit and scope of the present invention. In addition, the above-described embodiments are for describing the present invention, and do not limit the scope of the present invention. That is, the scope of the present invention is indicated by the claims rather than by the embodiments. Various modifications made within the scope of the claims and within the scope of the meaning of the invention equivalent thereto are regarded as being within the scope of the present invention.

### REFERENCE SIGNS LIST

1, 2 Printing system
10 Resultant product
20 Medium
30 Printing layer
100 Printing device
110 Processor
111 Printing execution unit
112 Printing history output unit
120 Storage device
121 Printing history
130 Communication interface
200 Printing instruction terminal
210 Processor
211 Printing instruction data generation unit
212 Printing history analysis unit
220 Storage device
221 Printing data
222 Printing device information
230 Communication interface
300 Network
310 Server
320 Management terminal

1. A printing device comprising:
a printing execution unit configured to execute printing of a printing surface identified by printing surface identification information based on printing instruction data including: resultant product identification information for identifying a resultant product of printing, a total printing surface number, which is a total number of the printing surface to be printed to obtain the resultant product, the printing surface identification information for identifying the printing surface, and printing data of the printing surface identified by the printing surface identification information; and
a printing history output unit configured to output a printing history indicating a result of printing executed based on the printing instruction data including the same resultant product identification information in association with the resultant product identification information.

2. The printing device as set forth in claim 1, wherein the printing history output by the printing history output unit includes printing progress information derived based on the printing surface identification information of the printing surface on which the printing execution unit has executed printing and the total printing surface number.

3. The printing device as set forth in claim 1, wherein the printing history output by the printing history output unit includes an ink consumption amount consumed by printing of the printing surface or a printing cost based on the ink consumption amount.

4. The printing device as set forth in claim 1, wherein the printing history output by the printing history output unit includes information indicating that printing has been completed or the printing surface identification information related to the printing surface on which an error has occurred when the number of the printing surfaces on which the printing execution unit has executed printing is the same as the total printing surface number.

5. (canceled)

6. A printing system comprising:
a printing device configured to execute printing of a printing surface identified by printing surface identification information based on printing instruction data including:
resultant product identification information for identifying a resultant product of printing, a total printing surface number, which is a total number of the printing surface to be printed to obtain the resultant product, the printing surface identification information for identifying the printing surface, and printing data of the printing surface identified by the printing surface identification information, and output a printing history indicating a result of printing in association with the resultant product identification information; and
an information processing terminal configured to output printing progress information or printing cost of the resultant product identified by the resultant product identification information based on the printing history output by the printing device.

7. The printing system as set forth in claim 6, wherein
the printing system includes a plurality of the printing devices configured to execute printing of different printing surfaces among a plurality of the printing surfaces, and
the information processing terminal outputs the printing progress information or the printing cost of the resultant product based on the printing history associated with the resultant product identification information received from the plurality of the printing devices.

8. The printing system as set forth in claim 7, wherein the printing instruction data including the resultant product identification information, the total printing surface number, the printing surface identification information for identifying each of the printing surface, and the printing data of each of the printing surface is transmitted to each printing device configured to execute printing of each printing surface determined based on the printing data of the plurality of the printing surfaces, and each of the printing device executes printing based on the printing instruction data received.

9. The printing system as set forth in claim 8, wherein the printing instruction data is transmitted to each of the printing device configured to execute printing of each of the printing surface determined based on at least one piece of management information of specifications, ink remaining amounts, and maintenance states of the plurality of the printing devices and the printing data of the plurality of the printing surfaces.

10. A manufacturing line comprising the printing device as set forth claim 1, wherein an operation of a preceding process or a subsequent process is controlled based on the printing history associated with the resultant product identification information.

11. A manufacturing method comprising the steps of:
a printing execution step of executing printing of a printing surface identified by printing surface identification information based on printing instruction data including resultant product identification information for identifying a resultant product of printing, a total printing surface number, which is a total number of the printing surface to be printed to obtain the resultant product, the printing surface identification information for identifying the printing surface, and printing data of the printing surface identified by the printing surface identification information;
an outputting step of outputting a printing history indicating a result of printing executed in the printing execution step in association with the resultant product identification information; and
a controlling step of controlling an operation of a preceding process or a subsequent process based on the printing history associated with the resultant product identification information.

12. A manufacturing line comprising the printing device as set forth in claim 2, wherein an operation of a preceding process or a subsequent process is controlled based on the printing history associated with the resultant product identification information.

13. A manufacturing line comprising the printing device as set forth in claim 3, wherein an operation of a preceding process or a subsequent process is controlled based on the printing history associated with the resultant product identification information.

14. A manufacturing line comprising the printing device as set forth in claim 4, wherein an operation of a preceding process or a subsequent process is controlled based on the printing history associated with the resultant product identification information.
